(19) United States
(12) Patent Application Publication
(10) Pub. No.: US 2026/0149108 A1
(43) Pub. Date: May 28, 2026

(54) BATTERY PACK WITH BOTTOM COVER AND ELECTRIC VEHICLE

(71) Applicant: SAMSUNG SDI CO., LTD., Yongin-si (KR)

(72) Inventors: Florian ALTENBURGER, Weiz (AT); Manuel BAUER, Tillmitsch (AT); Guenter FLOH, Graz (AT); Daniel PICHLER, Graz (AT); Mihael BREZNIK, Sveta Trojica (SI)

(21) Appl. No.: 19/318,055

(22) Filed: Sep. 3, 2025

(30) Foreign Application Priority Data
Nov. 26, 2024 (EP) 24215372.4

(51) Int. Cl. H01M 50/291; B60L 50/64; H01M 50/204; H01M 50/249; H01M 50/262; H01M 50/271

(52) U.S. Cl. CPC H01M 50/291; B60L 50/64; H01M 50/204; H01M 50/249; H01M 50/262; H01M 50/271; H01M 2220/20

(57) ABSTRACT

A battery pack including: a battery pack housing for accommodating a plurality of battery cells therein, the battery pack housing including a bottom plate; a bottom cover arranged below the bottom plate of the battery pack housing; and a corrugated sheet between the bottom plate of the battery pack housing and the bottom cover. The corrugated sheet is not directly fixed to the bottom plate of the battery pack.

### CROSS-REFERENCE TO RELATED APPLICATION

The present application claims priority to and the benefit of European Patent Application No. 24215372.4, filed on Nov. 26, 2024, in the European Patent Office, the entire disclosure of which is incorporated herein by reference.

### BACKGROUND

### 1. Field

Aspects of embodiments of the present disclosure relate to a battery pack with a bottom cover and an electric vehicle including the same.

### 2. Description of the Related Art

A battery module includes a plurality of battery cells connected together in series and/or in parallel. That is, the battery module is formed by interconnecting electrode terminals of the plurality of battery cells to each other, with the number of battery cells and connection configuration depending on a desired amount of power, and to provide a relatively high-power rechargeable battery.

Battery modules can have either a block design or a modular design. In the block design, each battery cell is coupled to a common current collector structure and a common battery management system, and the unit thereof is accommodated in a housing. In the modular design, pluralities of battery cells are connected together to form submodules, and several submodules are connected together to form the battery module. In automotive applications, battery systems may include a plurality of battery modules connected together in series to provide a desired voltage.

A battery pack is a set of any number of (usually identical) battery modules or individual battery cells. The battery modules or, respectively, the battery cells, may be connected in a series, parallel, or series/parallel configuration to provide the desired voltage, capacity, and/or power density. Components of a battery pack include the individual battery modules and interconnects, which provide electrical conductivity between the battery modules.

Mechanical integration of a battery pack is achieved by suitable mechanical connections between the individual components, for example, between the battery modules and between the battery modules and a supporting structure of, for example, the vehicle. These connections should remain functional and safe throughout the average service life of the battery system. Further, installation space and interchangeability specifications should be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors, such as bolts or screws. In other examples, the battery modules are confined by fastening side plates to lateral sides of the carrier framework. In some applications, cover plates may be fixed atop and below the battery modules.

The carrier framework of the battery pack is mounted to a carrying structure of, for example, the vehicle. When the battery pack is to be fixed at a bottom of the vehicle, the mechanical connection may be established from the bottom side by, for example, bolts passing through the carrier framework of the battery pack. The framework is usually made of aluminum or an aluminum alloy to lower the total weight of the construction.

A conventional battery system, despite any modular structure, usually includes a battery housing that acts as an enclosure to seal the battery system from the environment and to provide structural protection of the battery system's components. Housed battery systems are usually mounted as a whole into their application environment, for example, to an electric vehicle. Thus, replacement of defective or damaged system parts, for example, a defective battery submodule, requires dismounting the entire battery system and removal of its housing. Even defects of small and/or cheap system parts may require the dismounting and separate repair of the entire battery system or replacement of the entire battery system. Because high-capacity battery systems are expensive, large, and heavy, a repair procedure is burdensome, and the storage, for example, in the mechanic's workshop, of the bulky battery system is difficult.

### SUMMARY

Extra-large batteries often suffer structural problems due to their length and width. One hurdle in the development of EV batteries is to create strong bottom covers within a limited space to provide sufficient strength to pass so-called bollard impact tests.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery pack includes: a battery pack housing for accommodating a plurality of battery cells, the housing including a bottom plate; a bottom cover below the bottom plate of the battery pack housing; and a corrugated (or trapezoidal) sheet between the bottom plate of the battery pack housing and the bottom cover. The corrugated (or trapezoidal) sheet is not directly fixed to the bottom plate of the battery pack housing.

According to another embodiment of the present disclosure, an electric vehicle includes the above-described battery pack.

Further aspects and features of the present disclosure can be learned from the following description.

### BRIEF DESCRIPTION OF THE DRAWINGS

Aspects and features of the present disclosure will become apparent to those of ordinary skill in the art by describing, in detail, embodiments of the present disclosure with reference to the attached drawings, in which:

FIG. 1 is a schematic cross-sectional view of a battery pack according to an embodiment.

FIG. 2 is a perspective view of a bottom cover according to an embodiment.

FIG. 3 is a sectional view of the bottom of the bottom cover shown in FIG. 2 along the line A-A′.

FIG. 4 is a schematic view of an electric vehicle according to an embodiment.

### DETAILED DESCRIPTION

Reference will now be made, in detail, to embodiments of the present disclosure, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery pack includes at least the following. First, a battery pack housing for accommodating a plurality of battery cells therein. The battery pack housing includes a bottom plate. Secondly, the battery pack includes a bottom cover arranged below the bottom plate of the battery pack housing. Thirdly, the battery pack includes a corrugated (or trapezoidal) sheet disposed between the bottom plate of the battery pack housing and the bottom cover. The corrugated (or trapezoidal) sheet is not directly (i.e., is only indirectly) fixed to the bottom plate of the battery pack housing.

For example, the corrugated (or trapezoidal) sheet is held or assembled between the bottom plate of the battery pack housing and the bottom cover, but there are no fixing elements that create a direct mechanical connection between the corrugated (or trapezoidal) sheet and the bottom plate. Rather, there may be a (for example, detachable) mechanical connection of the corrugated (or trapezoidal) sheet to the bottom cover; for example, the corrugated (or trapezoidal) sheet may be (directly) fixed to the bottom cover of the battery pack. Thereby, the bottom cover together with the corrugated (or trapezoidal) sheet can be removed from the remainer (or rest) of the battery pack in one work step, for example, for damage or defect replacement.

Generally, corrugated sheets (that is, a sheet panel having a wavy profile) or trapezoidal sheets (that is, a sheet panel having a rectangular or square wavy profile) exhibit exceptional rigidity while remaining thin. Thereby, the corrugated (or trapezoidal) sheet is light weight compared to a solid structure. Additionally, in case of an impact, the corrugated (or trapezoidal) sheet with its hollow sections may deform and dampen impacts without deforming to (or deforming) the inside of the battery pack housing. The corrugated (or trapezoidal) sheet may have a thickness in the range of about 0.1 mm to about 5 mm. In some embodiments, the thickness of the corrugated (or trapezoidal) sheet may be in a range between about 0.5 mm and about 2.0 mm. This range optimizes stability and weight. In some embodiments, two or more corrugated (or trapezoidal) sheet may be provided in a stacked manner. Despite its light weight, corrugated (or trapezoidal) sheet exhibit good load-bearing capacity and can withstand high mechanical loads. Corrugated sheets are lighter, while trapezoidal sheets have greater rigidity and stability. The corrugated (or trapezoidal) sheet may be formed of a metallic material, for example, stainless steel.

The bottom cover is fitted to the underside of the battery pack to form part of the electric vehicle floor in use. The bottom cover is designed to protect against stone chipping and weathering at the lower side of the battery pack. The bottom cover may have a thickness in a range of about 0.5 mm to about 5 mm. In some embodiments, the thickness of the bottom cover may be in a range between about 1.0 mm and about 3 mm. The bottom cover may be formed of a metallic material, for example, stainless steel.

The bottom cover may be detachable fixed (or connected or coupled) to the bottom plate of the battery pack housing. Detachable fixation of the bottom cover to the bottom plate may facilitate repair of the battery pack, for example, after an accident or impact by an obstacle from below the battery pack. According to one embodiment, one or more fixing elements are attached to a side of the bottom cover opposite the bottom plate of the battery pack housing, and the fixing elements are configured to provide detachable fixation of the corrugated sheet to the bottom plate. The fixing elements may be formed integrally with or separately from the bottom cover. The fixing elements may be aligned with one or more through holes for fixation of the fixing elements to the bottom plate of the battery pack housing by separate fixing members, for example, screws. The fixing elements may have an oval shape. In some embodiments, the fixing elements may have a plateau shape. In some embodiments, the through holes may have different diameters from each other.

According to another embodiment, the battery pack further includes one or more foam sheets disposed between the corrugated (or trapezoidal) sheet and the bottom plate. The foam sheets may dampen contact between the corrugated (or trapezoidal) sheet and/or the bottom cover with the bottom plate to reduce vibrations and/or accommodate for tolerances between the corrugated (or trapezoidal) sheet and the bottom cover. Further, a firm seat of the bottom cover on the bottom plate is ensured.

According to another embodiment, an electric vehicle includes the battery pack as described above. As mentioned above, the battery pack has beneficial characteristics for electrical vehicles, that is, high impact resistance. The benefits of the above-described battery pack are, however, not limited to impacts from below but protect against side impacts and front impacts. Thereby, the battery pack may be prevented from deformation and damage to the battery cells may be prevented.

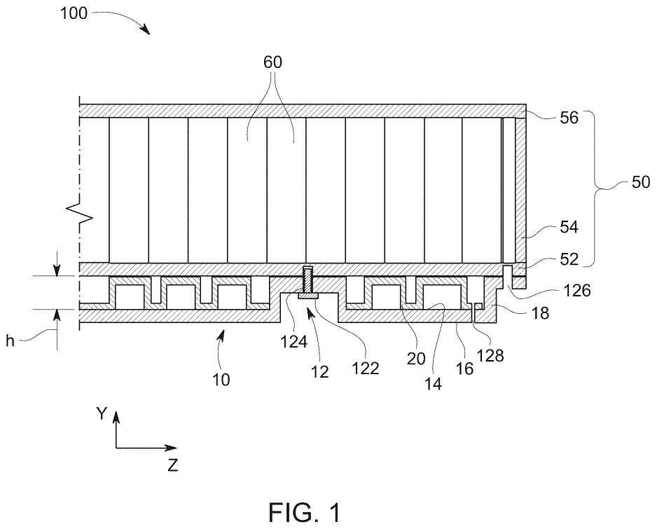

FIG. 1 is a schematic cross-sectional view of a part (or portion) of a battery pack 100 according to an embodiment. The battery pack 100 includes a battery pack housing 50 accommodating a plurality of battery cells 60 therein. The battery cells 60 are each encased in (or accommodated in) a battery pack housing 50. The battery pack housing 50 includes a bottom plate 52, a plurality of side walls 54, and a top cover 56. Thus, the battery pack housing 50 encloses (or forms) a distinct volume.

Further, a bottom cover 10 is arranged below the bottom plate 52 of the battery pack housing 50, between which a corrugated (or trapezoidal) sheet 20 is disposed. For example, the corrugated (or trapezoidal) sheet 20 fills the space between the bottom plate 52 of the battery pack housing 50 and the bottom cover 10. In some embodiments, the corrugated (or trapezoidal) sheet 20 is directly fixed the bottom cover 10 through one or more first through holes (or first openings) 128. In some embodiments, the corrugated (or trapezoidal) sheet 20 is fixed to the bottom cover 10 by rivets extending through the first through hole(s) 128. However, any suitable fixing elements may be used. The corrugated (or trapezoidal) sheet 20 is not fixed to the bottom plate 52 of the battery pack housing 50.

The bottom cover 10 includes one or more fixing elements 12 attached to an inner side 14 of the bottom cover 10 opposite the bottom plate 52 of the battery pack housing 50. The fixing elements 12 are configured to provide (or assist) detachable fixation of the bottom cover 10 together with the corrugated (or trapezoidal) sheet 20 to the bottom plate 52. In the illustrated embodiment, one or more second through holes (or second openings) 124 are formed in the bottom cover 10 to accommodate the fixing elements 12, and a plurality of third through holes (or third openings) 126 are formed at an edge of (e.g., a peripheral edge of) the bottom cover 10.

In some embodiments, the corrugated (or trapezoidal) sheet 20 is one single sheet having cutouts (or openings) to accommodate the fixing elements 12. In some embodiments, the fixing elements 12 are integrally formed from the bottom cover 10, for example, by punching. However, in other embodiments, the fixing elements 12 may be manufactured separately and fixed to the bottom cover 10 by any suitable fixation method, for example, in a form-fitting manner, a force-fitting manner, and/or a materially bonded manner.

The bottom plate 52 has a corresponding opening for accommodating a fixing member, for example, a screw 122, at the location of the second through hole 124. The screw 122 extends through the second through hole 124 and is screwed into a corresponding opening in the bottom plate 52 having a corresponding thread. The screw 122 fixes the bottom cover 10 to the bottom plate 52. Thereby, the corrugated (or trapezoidal) sheet 20 is at least form-fittingly held between the bottom cover 10 and the bottom plate 52. Additionally, the bottom cover 10 is similarly fixed to the bottom plate 52 through the at least one third through hole 126. Another fixing member extends through the third through hole 126 and is screwed into a corresponding opening in the bottom plate 52 having a thread corresponding to the other fixing member.

The bottom cover 10 includes bottom cover side walls 18 having a height (e.g., a dimension in the x-direction). The bottom cover side walls 18 of the bottom cover 10 enclose (or form) a trough-shaped volume such that the corrugated (or trapezoidal) sheet 20 is accommodated therein. The inner height h of the bottom cover 10 extending from the inner side 14 to the bottom plate 52 is equal to the height of the corrugated (or trapezoidal) sheet 20.

In the illustrated embodiment, the corrugated (or trapezoidal) sheet 20 has a trapezoidal shape, for example, it has a rectangular wavy profile. The flat crests of the trapezoidal sheet 20 contact the bottom plate 52, and the flat troughs of the trapezoidal sheet 20 contact the bottom cover 10.

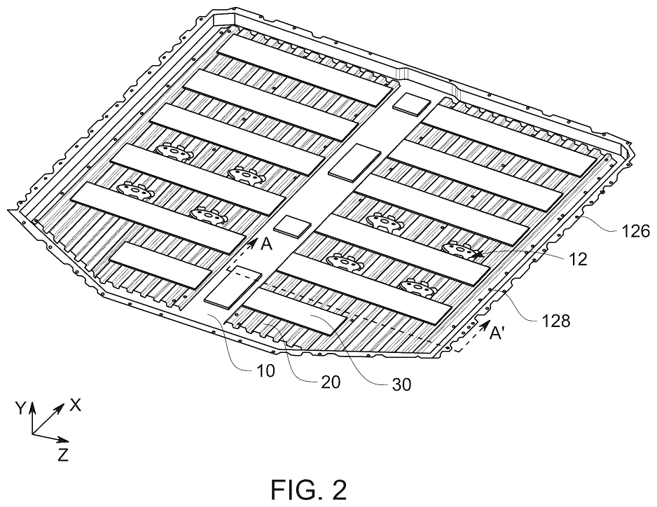

FIG. 2 is a perspective view of a bottom cover 10 according to another embodiment. Unless described otherwise, all explanations from above apply accordingly. In FIG. 2, the battery pack housing 50 with the bottom plate 52 is not shown for convenience of explanation. Referring to FIG. 2, a plurality of foam sheets 30 are located on the corrugated (or trapezoidal) sheet 20. For example, the bottom cover 10 together with the corrugated (or trapezoidal) sheet 20, as shown in FIG. 1, is shown in a removed state from the battery pack housing 50 in FIG. 2. This is due to the bottom cover 10 being detachably connected to the bottom plate 52, which facilitates easy replacement of the bottom cover 10. The foam sheets 30 are disposed between the corrugated (or trapezoidal) sheet 20 and the bottom plate 52. Briefly referring back from the embodiment shown in FIG. 2 to the embodiment shown in FIG. 1, the cross-sectional view of FIG. 1, despite being a different embodiment, would be taken at a position with one fixing elements 12 but without a foam sheet along a line parallel to the line A-A′ in FIG. 2.

In FIG. 2, the corrugated (or trapezoidal) sheet 20 includes (or is made of) two parts, one for a left side and one for a right side of the bottom cover 10. Left and right refer to the z-direction. Front and rear extend along the x-direction, in which the front is the side closest to the viewer in FIG. 2. A gap without a corrugated (or trapezoidal) sheet 20 is formed in a middle section of the bottom cover 10. The middle section extends from a front edge to a rear edge of the bottom cover 10. However, one or more pieces of foam sheet 30 are present in the middle section of the bottom cover 10. For example, two longer pieces of foam sheet 30 and two shorter pieces of foam sheet 30 are intermittently aligned in longitudinal direction (e.g., in the x-direction) of the bottom cover 10.

In the illustrated embodiment, each corrugated (or trapezoidal) sheet 20 has four cutouts for accommodating four fixing elements 12, respectively. Each fixing elements 12 corresponds to a centrally positioned second through hole 124. The second though holes 124 are used for fixation of the bottom cover 10 to the bottom plate 52 of the battery pack 100. Additionally, the bottom cover 10 has third through holes 126, which are also used for fixation to the bottom plate 52. Further, the corrugated (or trapezoidal) sheet 20 has first through holes 128 at the edge of the corrugated (or trapezoidal) sheet 20. Thereby, the corrugated (or trapezoidal) sheet 20 is fixed to the bottom cover 10.

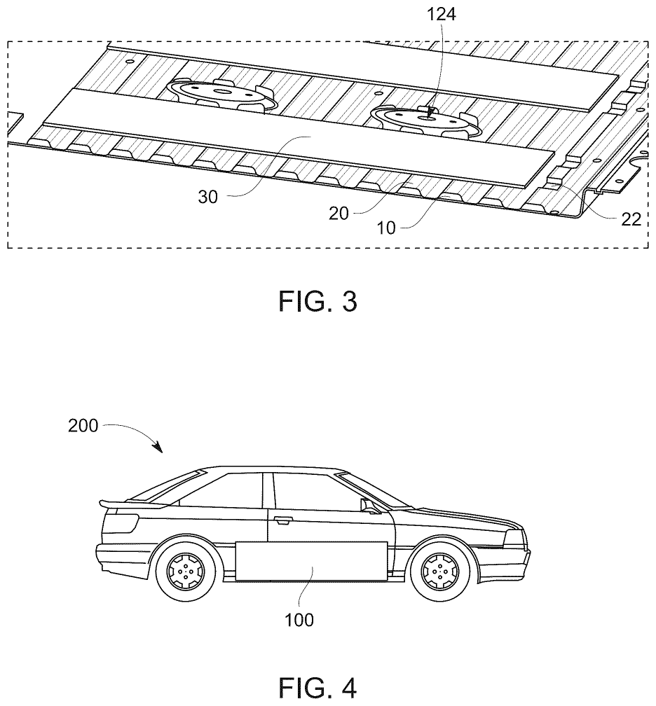

FIG. 3 is a detailed sectional view of the bottom cover 10 shown in FIG. 2 along the line A-A′. Unless described otherwise, all of the explanations above apply accordingly. As can be seen in FIG. 3, the fixing elements 12, having an oval or plateau shape, are completely surrounded by (e.g., are completely surrounded along their respective peripheries by) the corrugated (or trapezoidal) sheet 20. The foam sheet 30 is displaced from (or offset from) the openings in the corrugated (or trapezoidal) sheet 20 accommodating the fixing elements 12. The foam sheet 30 extends in a width direction (e.g., the z-direction) of the bottom cover 10.

In the illustrated embodiment, the foam sheet 30 is at least partly accommodated within a crest of the corrugated (or trapezoidal) sheet 20. For example, the foam sheet 30 is at least partly located in an area between two crests of the corrugated (or trapezoidal) sheet 20. Thereby, the foam sheet 30 is not completely compressed during installation of the bottom cover 10 to the bottom plate 52 and remains flexible. To accommodate the foam sheet 30, the crests of the corrugated (or trapezoidal) sheet 20 has depressions 22. The foam sheet 30 covers at least about 90% of the width (e.g., in the z-direction) of the depressions 22. The corrugated (or trapezoidal) sheet 20 is a reinforcement inlay.

FIG. 4 is a schematic view of an electric vehicle 200 according to an embodiment. Unless described otherwise, all of the explanations above apply accordingly. The electric vehicle 200 includes the battery pack 100 as described above. The battery pack 100 includes the bottom cover 10 to protect the bottom of the battery pack 100. The bottom cover 10 is detachable from the bottom plate 52 to facilitate maintenance and/or repair.

### DESCRIPTION OF SOME REFERENCE SYMBOLS

10 bottom cover
12 fixing elements
14 inner side
16 outer side
18 bottom cover side wall
20 corrugated (or trapezoidal) sheet
22 depression
30 foam sheet
50 battery pack housing
52 bottom plate
54 side wall
56 top cover
60 battery cell
100 battery pack
122 screw
124 second through hole
126 third through hole
128 first through hole
200 electric vehicle

What is claimed is:

1. A battery pack comprising:
a battery pack housing for accommodating a plurality of battery cells therein, the battery pack housing comprising a bottom plate;
a bottom cover arranged below the bottom plate of the battery pack housing; and
a corrugated sheet between the bottom plate of the battery pack housing and the bottom cover,
wherein the corrugated sheet is not directly fixed to the bottom plate of the battery pack.

2. The battery pack as claimed in claim 1, wherein the corrugated sheet is fixed to the bottom cover.

3. The battery pack as claimed in claim 2, further comprising a foam sheet between the corrugated sheet and the bottom plate.

4. The battery pack as claimed in claim 3, wherein the bottom cover is detachably fixed to the bottom plate.

5. The battery pack as claimed in claim 4, further comprising fixing elements attached to a side of the bottom cover opposite the bottom plate of the battery pack housing, the fixing elements being configured to detachably fix the corrugated sheet to the bottom plate.

6. The battery pack as claimed in claim 1, further comprising a foam sheet between the corrugated sheet and the bottom plate.

7. The battery pack as claimed in claim 6, wherein the bottom cover is detachably fixed to the bottom plate.

8. An electric vehicle comprising the battery pack as claimed in claim 1.
